(19) United States
(12) Patent Application Publication
(10) Pub. No.: US 2026/0009651 A1
(43) Pub. Date: Jan. 8, 2026

(54) METHOD AND DEVICE FOR GENERATING ROAD-BASED, USERDEFINED ROUTE

(71) Applicant: 42dot Inc., Seoul (KR)

(72) Inventors: Jung Hwan HWANG, Seongnam (KR); Seung Hyun JI, Seongnam (KR); Hwa Hyun SHIN, Seongnam (KR)

(21) Appl. No.: 19/256,215

(22) Filed: Jul. 1, 2025

(30) Foreign Application Priority Data
Jul. 2, 2024 (KR) 10-2024-0087169

(51) Int. Cl. G01C 21/36

(52) U.S. Cl. CPC G01C 21/3608

(57) ABSTRACT

A method of generating a road-based, user-defined route includes: determining whether a received route generation input includes an input about a road; determining, based on the route generation input including the input about the road, a validity of the input and optionally correcting the input based on a result of the determining of the validity; determining a scope of reflection of the road by comparing a first area based on the route generation input with a second area based on the input; and generating a user-defined route that reflects the determined scope of reflection.

### CROSS-REFERENCE TO RELATED APPLICATION

This application is based on and claims priority under 35 U.S.C. § 119 to Korean Patent Application No. 10-2024-0087169, filed on Jul. 2, 2024, in the Korean Intellectual Property Office, the disclosure of which is incorporated by reference herein in its entirety.

### BACKGROUND

### 1. Field

The present disclosure relates to a method of generating a route by receiving a user's input, and more particularly, to a method of generating a route for a user to travel to a destination, by receiving an input about a road from the user, and a device for implementing the method.

### 2. Description of the Related Art

Various route search applications may be installed in a navigation system mounted in a vehicle. Related-art route search applications may receive an origin and a destination from a user in various ways to generate multiple routes from the origin to the destination, and visually provide the generated routes to the user through a display of a navigation system, however, the process of inputting a waypoint that the user prefers or wants to avoid is complicated.

### SUMMARY

An objective of the present disclosure is to provide a method and device for generating a road-based, user-defined route.

Additional aspects will be set forth in part in the description which follows and, in part, will be apparent from the description, or may be learned by practice of the presented embodiments of the disclosure.

According to an embodiment of the present disclosure, a method includes: determining whether a received route generation input includes an input about a road; determining, based on the route generation input including the input about the road, a validity of the input and optionally correcting the input based on a result of the determining of the validity; determining a scope of reflection of the road by comparing a first area based on the route generation input with a second area based on the input; and generating a user-defined route that reflects the determined scope of reflection.

In the method, the route generation input may further include information about a destination of the route.

In the method, the input about the road may be an input via a voice of a user.

In the method, the determining of whether the received route generation input includes the input about the road may be performed based on whether the received route generation input matches any one of road names, tunnel names, bridge names, and facility names that are stored in a database.

In the method, the correcting of the input may include correcting a misspelling in the input about the road.

In the method, the correcting of the input may include correcting the input about the road based on another name, a nickname, or an old name for the input about the road.

In the method, the determining of whether the received route generation input includes the input about the road may include paraphrasing the input about the road and then determining whether the received route generation input includes the input about the road.

In the method, the determining of the scope of reflection of the road may include defining a first area as a rectangular range generated based on an origin and a destination included in the route generation input, defining a second area as a rectangular range generated based on the input, and determining the scope of reflection based on an overlap between the first area and the second area.

In the method, the determining of the scope of reflection of the road may include determining the scope of reflection based on a road that is common to both the first area and the second area.

In the method, the determining of the scope of reflection of the road may include determining the scope of reflection based on an overlap between a line defined by an origin and a destination in the first area, and a road in the second area.

In the method, the generating of the user-defined route may include: determining whether a preferred point to which a first weight is assigned exists in the first area; and generating the user-defined route such that the preferred point is included in the user-defined route based on the first weight.

In the method, the generating of the user-defined route may include: determining whether an avoidance point to which a second weight is assigned exists in the first area; and generating the user-defined route such that the avoidance point is excluded from the user-defined route based on the second weight.

According to another embodiment of the present disclosure, a device includes: a memory storing at least one program and; a processor configured to execute the at least one program to perform an operation, wherein the processor is further configured to determine whether a received route generation input includes an input about a road, determine, based on the route generation input including the input about the road, a validity of the input and optionally correct the input based on a result of the determining of the validity, determine a scope of reflection of the road by comparing a first area based on the route generation input with a second area based on the input, and generate a user-defined route that reflects the determined scope of reflection.

According to an embodiment of the present disclosure, there may be provided a computer-readable recording medium having recorded thereon a program for executing the method.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating an overall system for implementing a method according to the present disclosure;

FIG. 2 is a flowchart illustrating an example of a method of generating a user-defined route, according to the present disclosure;

FIG. 3 is a diagram for describing an overlapping area between an origin-destination (OD) minimum bounding rectangle (MBR) and a road MBR in operation S235 of FIG. 2;

FIG. 4 is a diagram schematically illustrating an example of determining, in operation S240 of FIG. 2, whether a road corresponding to a road MBR actually exists within an overlapping area;

FIG. 5 is a diagram for describing an example of a method according to the present disclosure;

FIG. 6 is a diagram for describing an example of an entire road included in a road MBR;

FIG. 7 is a diagram schematically illustrating a user-specified road of FIG. 6 divided into two sections;

FIG. 8 is a diagram schematically illustrating an example in which a user-specified road is fully reflected in a user-defined route by a method according to the present disclosure;

FIG. 9 is a diagram schematically illustrating an example in which a user-specified road is partially reflected in a user-defined route by a method according to the present disclosure;

FIG. 10 is a diagram schematically illustrating another example in which a user-specified road is partially reflected in a user-defined route by a method according to the present disclosure;

FIG. 11 is a flowchart illustrating an example of a method according to the present disclosure; and

FIG. 12 is a block diagram illustrating an example of a route generation device.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As the present disclosure allows for various changes and numerous embodiments, particular embodiments will be illustrated in the drawings and described in detail. The effects and features of the present disclosure and methods of achieving them will become clear with reference to the embodiments described in detail below with the drawings. However, the present disclosure is not limited to the embodiments disclosed below, and may be implemented in various forms.

Hereinafter, embodiments of the present disclosure will be described in detail with reference to the accompanying drawings, and the same or corresponding components will be denoted by the same reference numerals when described with reference to the accompanying drawings, and thus, their descriptions that are already provided will be omitted.

In the following embodiments, terms such as “first,” “second,” etc., are used only to distinguish one component from another, and such components must not be limited by these terms.

In the following embodiments, the singular form is intended to include the plural form, unless the context clearly indicates otherwise.

In the following embodiments, the terms “comprise,” “include,” “have,” and the like specify the presence of stated features or components, but do not preclude the presence or addition of one or more other features or components.

When a certain embodiment may be differently implemented, particular operations may be performed differently from the sequence described herein. For example, two processes, which are successively described herein, may be substantially simultaneously performed, or may be performed in a process sequence opposite to a described process sequence.

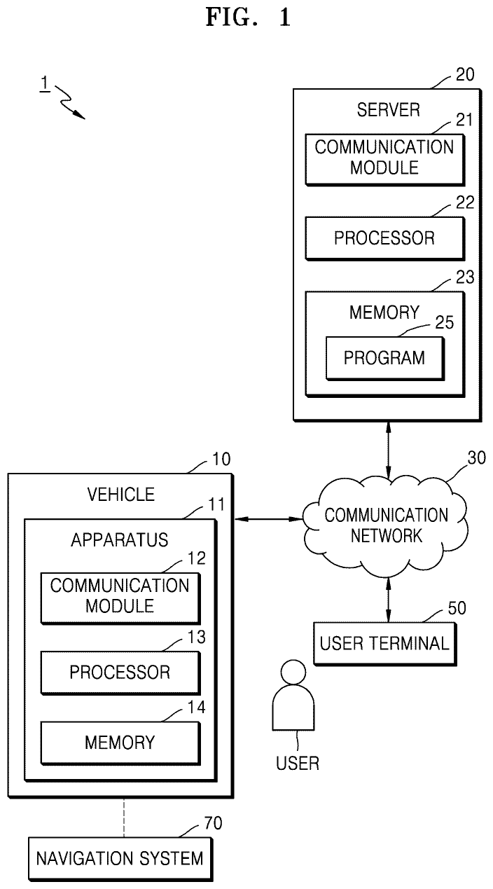

FIG. 1 is a diagram schematically illustrating an overall system for implementing a method according to the present disclosure.

Referring to FIG. 1, it may be seen that a system 1 according to an embodiment of the present disclosure includes a vehicle 10 equipped with a device 11, a server 20, and a user terminal 50. Herein, the device 11, the server 20, and the user terminal 50 may be electrically connected to each other via a communication network 30.

A user may operate the vehicle 10 directly while on board, or may control the operation of the vehicle 10 via an external device (e.g., a remote controller) without being on board. That is, in the present disclosure, a “user” refers to a person associated with the vehicle 10, and according to an embodiment, may be referred to as a “driver”. In particular, in the present disclosure, a user may be an owner who has purchased and owns the vehicle 10, or, according to an embodiment, may be a shared user who has been granted sharing authority for the vehicle 10 from its owner and is allowed to use the vehicle 10 for a predetermined period.

In the present disclosure, the vehicle 10 may be a conventional internal combustion engine vehicle that operates with an engine consuming gasoline or diesel, or, according to an embodiment, may be an electric vehicle whose driving unit is a motor. In this case, the vehicle 10 may omit a fuel tank for storing fuel and include a large-capacity battery or a battery pack for supplying power to the motor.

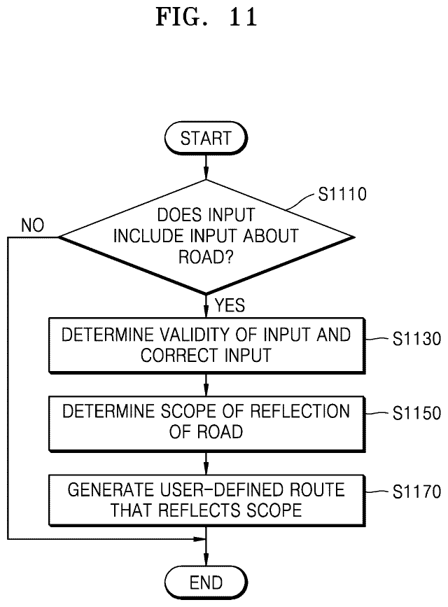

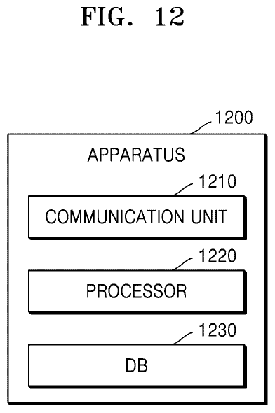

The device 11 may be a type of telematics terminal, and may be mounted on or installed in the vehicle 10. The device 11 may include a communication module 12 for communicating with an external device, a processor 13 configured to perform various data processing or computations, and a memory 14 for storing various pieces of data used by the processor 13. Furthermore, in the present disclosure, the device 11 is not limited to a physical device and may be a logical device, and for example, the device 11 may be a program that is stored in an electronic module within the vehicle 10 and then executed. In the present disclosure, the device 11 performs data processing via the processor 13 to generate information to be output from a navigation system 70 mounted on the vehicle 10, and specific functions of the device 11 will be described below with reference to FIGS. 11 and 12.

According to an embodiment, the communication module 12, the processor 13, and the memory 14 may comprise circuitry to perform their functions.

The server 20 may support a telematics service for the vehicle 10 equipped with the device 11. To this end, the server 20 may include a communication module 21 and may be electrically connected to the vehicle 10 and the device 11 of the vehicle 10 via the communication module 21.

Furthermore, the server 20 includes a memory 23 storing a program 25 for supporting a telematics service. A processor 22 of the server 20 may perform data processing or computations for the telematics service by executing the program 25 stored in the memory 23. The processor 22 may load commands or data into the memory 23 (e.g., volatile memory), process the stored commands or data, and store resulting data in the memory 23 (e.g., non-volatile memory). For example, the server 20 may be a cloud server, but is not limited thereto.

The memory 23 of the server 20 may store various types of information about the vehicle 10. According to an embodiment, the information about the device 11 may be a serial number of a telematics terminal mounted on the vehicle 10. In addition, the memory 23 of the server 20 may also store personal information of a driver who drives the vehicle 10 while on board.

According to an embodiment, the communication module 21, the processor 22, and the memory 23 may comprise circuitry to perform their functions.

The communication network 30 may perform a function of connecting the vehicle 10, the server 20, and the user terminal 50, which are components of the overall system 1, and may include various wired/wireless communication networks such as a data network, a mobile communication network, or the Internet. In particular, in the present disclosure, the communication network 30 includes not only mobile communication networks currently in use, but also old-generation deprecated mobile communication networks, and thus may be any one of a Global System for Mobile communications (GSM) network, a code-division multiple access (CDMA) network, a wideband CDMA (WCDMA) network, a CDMA2000 network, a Long-Term Evolution (LTE) network, an LTE-Advanced (LTE-A) network, a 5th Generation (5G) network, and a 6th Generation (6G) mobile communication network expected to be serviced in 2030. In addition, the communication network 30 may also include a network implemented via satellite communication, such as STARLINK.

The user terminal 50 may be an electronic device belonging to a purchaser of the vehicle 10 equipped with the device 11, and for example, may be a smart phone or a remote controller, but is not limited thereto. In addition, the user terminal 50 may store a program (e.g., an application) for implementing various telematics services. According to an embodiment, the user terminal 50 may be mounted on the vehicle 10, and in this case, the user terminal 50 may also function as the device 11 of the vehicle 10. That is, according to an embodiment, the user terminal 50 may have a similar configuration to the device 11.

The navigation system 70 may output, as visual information, a route generated based on information about a destination input by a user on board the vehicle 10. Hereinafter, a route generated based on a user's input as described above will be referred to as a “user-defined route”. The user's input may be a typing input via a keypad or a voice input via a microphone. Furthermore, the user's input may be provided to the device 11 instead of being directly provided to the navigation system 70.

According to an embodiment, the navigation system 70 may be a separate electronic device including a display or the navigation system 70 may be a part of the device 11. The navigation system 70 may have a separate processor, a memory and a network interface. Alternatively, the navigation system 70 may be a part of the device 11, connected via a bus to other components of the device 11, having a display. The display of the navigation system 70 may comprise circuitry to perform its displaying function.

In the present disclosure, the navigation system 70 may function as a simple display that receives and visualizes a result processed by the device 11, or, according to an embodiment, may be incorporated into the device 11 and thus omitted. Furthermore, as another embodiment, the navigation system 70 may function as a display that receives and visualizes a result that is processed by the processor 22 of the server 20 executing a user-defined route generation program (not shown), which is an instance of the program 25 stored in the memory 23.

The device 11 and/or the navigation system 70 may include a user interface that receives a user input and/or generates output to the user. The user interface may be a touch screen or includes soft/hard buttons. The user interface may include a display. The user interface may generate visual, audio, and/or haptic output. The device 11 and/or the navigation system 70 may generate different outputs depending on information or notifications that the device 11 and/or the navigation system 11 delivers to the user.

In one embodiment, the notification may be provided in the form of vibration, voice, image, or text. The device 11 and/or the navigation system 11 may include a vibration module such as a haptic actuator. The haptic actuator may include a vibration motor, an eccentric rotating mass (ERM) actuator, or a linear resonant actuator (LRA). The vibration module may generate different vibrations depending on the notification, by changing the strength, pattern, and/or length of the vibration. For example, depending on the information or the notification, the device 11 and/or the navigation system 11 may modify the notification to make it more prominent. For example, the vibration module may generate stronger vibration.

According to an embodiment, the device 11 or the navigation system 70 may include a microphone that recognizes the voice of the user and may process, using processing circuitry, the voice to recognize a command. The processing circuitry in the device 11 or the navigation system 70 that processes the voice of the user may perform encoding and decoding of voice data of the voice of the user.

The present disclosure is not limited to the components illustrated in FIG. 1. For example, the system 1 may further include components other than the device 11, the server 20, and the user terminal 50. In addition, other components may be added to, or some components may be omitted from, the vehicle 10, the device 11, the server 20, and the user terminal 50.

According to an embodiment, the device 11 and the navigation system 70 may a part of or may constitute a vehicle control system to control the vehicle 10 and to provide information assisting traveling of the vehicle 10. The vehicle control system may provide assist for driver's control of the host vehicle.

The vehicle control system may be an Advanced Driver Assistance system (ADAS). Here, the ADAS may represent various types of cutting-edge driver assist systems, and, as driver assist systems, for example, an Autonomous Emergency Braking (AEB) system, a Smart Parking Assistance System (SPAS), a Blind Spot Detection (BSD) system, an Adaptive Cruise Control (ACC) system, a Lane Departure Warning System (LDWS) system, a Lane Keeping Assist System (LKAS), a Lane Change Assist System (LCAS), and the like may be included. However, the driver assist systems are not limited thereto.

Here, the vehicle 10 may represent a vehicle that has a motor mounted thereon and is produced to move on the ground by rolling wheels using power of the motor or using power from a combustion engine of fossil fuel without using railroads or installed lines. In addition, the vehicle 10 may be an electric vehicle that is a vehicle having electricity as its power and obtains driving energy by rotating a motor using electricity accumulated in a battery instead of obtaining driving energy from combustion of fossil fuel.

The control of the vehicle 10 may include control of steering wheel, speed (acceleration), or braking of the vehicle. The vehicle control system may be applied to a manned vehicle in which a driver gets and controls the host vehicle (20) and an autonomous traveling vehicle.

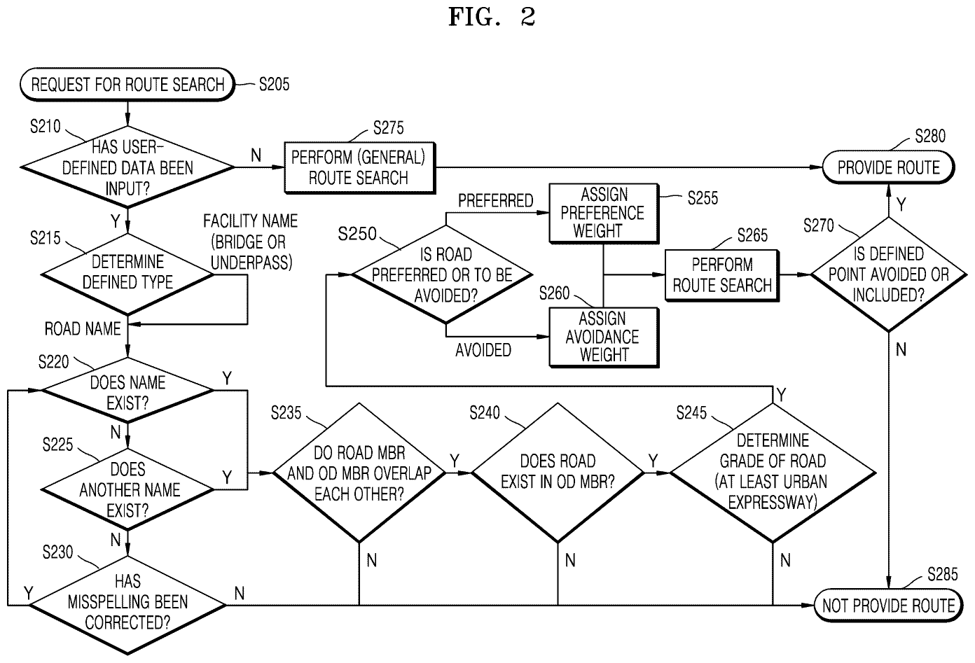

FIG. 2 is a flowchart illustrating an example of a method of generating a user-defined route, according to the present disclosure.

It is assumed that the entity performing each operation of the method illustrated in FIG. 2 is the device 11 described above with reference to FIG. 1, and for the purpose of distinction from other general devices, the device 11 may also be referred to as a route generation device 200. Hereinafter, descriptions will be provided with reference to FIG. 1.

The route generation device 200 may receive a request for a ‘route search’ from a user on board the vehicle 10 (S205). The request for a ‘route search’ in operation S205 is an input for generating a ‘user-defined route’ according to the present disclosure, and thus, from the perspective of the route generation device 200, this request may also be referred to as a ‘route generation input’.

The route generation device 200 may determine whether the route generation input received in operation S205 includes data necessary for generating a user-defined route (S210). In operation S210, when the route generation input includes the data necessary for generating a user-defined route, the route generation device 200 considers that the ‘route generation input’ has been input as valid ‘user-defined data’, and proceeds to operation S215 to determine a type defined by the user's input. In the present disclosure, the data necessary for generating a user-defined route may be an ‘input about a road’, which will be described below. In addition, when it is determined in operation S210 that user-defined data has not been input, the route generation device 200 may search for a route based on an origin and a destination according to a general operational routine of the navigation system 70 (S275), and provide the route searched in operation S275 to the user in the form of visual information (S280).

The route generation device 200 may perform image processing and synthesize visual information for the route based on the map data stored in the memory. The synthesized visual information for the route may be displayed on device 11 and/or the navigation system 70.

Subsequently, the route generation device 200 may determine the type of definition defined for data necessary for generating a user-defined route in the user-defined data (S215). In operation S215, the route generation device 200 determines whether the user-defined data includes a road name or a facility name. For example, when the user-defined data includes ‘Gangbyeon Expressway’, the route generation device 200 determines that a road name is included in the user-defined data, and as another example, when the user-defined data includes the bridge name ‘Dongho Bridge’, the route generation device 200 determines that a facility name is included in the user-defined data. In operation S210, when the route search request in operation S205 includes a road name or a facility name such as ‘Gangbyeon Expressway’ or ‘Dongho Bridge’, the route generation device 200 may determine that user-defined data, which includes an ‘input about a road’, has been input.

Data stored in a memory included in the route generation device 200 or stored in an external database communicating with the route generation device 200 is labeled according to the type (e.g., road or facility) determined in operation S215, and a process of distinguishing between roads and facilities, such as that in operation S215, may increase the efficiency of searching by the name of a road or facility in operation S220, which will be described below. As another example, Article 2 of the Road Act of the Republic of Korea defines “road” as a broad concept that includes facilities such as bridges and underpasses, and thus, depending on the labeling status of data stored in the memory or the database, operation S215 may be omitted in the present disclosure.

The route generation device 200 may determine whether the name identified as a road or a facility in operation S215 actually exists (S220). For example, the route generation device 200 may ascertain whether the name identified in operation S215 is an actually existing name, based on whether the identified name matches any one of the names of actual roads and facilities that are pre-stored in the memory or external database. Operation S220 is a preliminary process for searching general map data for a location (a road or a facility) that the user wishes to pass through or avoid, so as to obtain road information from the map data.

When the name identified as a road or facility is not an actually existing name, the route generation device 200 may determine whether a name that refers to the same subject as the identified name but has a different notation exists (S225). The route generation device 200 may identify other names that are matched with the pre-stored names of actual roads and facilities in the memory or external database, or other names that are retrieved by related search queries for the actual roads and facilities. For example, although ‘Jungbu Naeryuk Expressway Branch’ and ‘Guma Expressway’ are different notations, they actually refer to the same road, and thus, when ‘Guma Expressway’ is input, the route generation device 200 may determine, from a database, that ‘Jungbu Naeryuk Expressway Branch’ is a name for the same road as ‘Guma Expressway’ but with a different notation.

When it is determined that the name identified as a road or facility does not actually exist in the memory or external database, and that a name with a different notation also does not exist, the route generation device 200 may determine whether the name identified as a road or facility contains a misspelling (S230). For example, when ‘Olympi Boulevard’ is input, this is a misspelling of ‘Olympic Boulevard’, and when ‘Donghwa Bridge’ is input, the route generation device 200 may determine ‘Donghwa Bridge’ is a misspelling of ‘Dongho Bridge’, and automatically correct it. When it is determined that the name identified as a road or facility does not actually exist in the memory or external database, does not have another name with a different notation, and does not contain a misspelling, the route generation device 200 does not provide a route corresponding to the identified name (S285). On the contrary, when it is determined in operation S230 that the name identified as a road or facility contains a misspelling, the route generation device 200 may correct the name identified as a road or facility and then perform operation S220 again based on the corrected name.

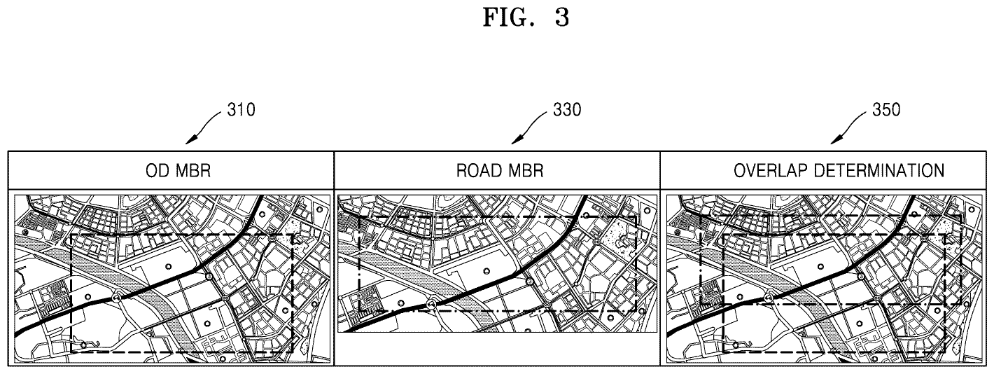

When the name identified as a road or facility is found in the memory or external database in operation S220, or when it is determined in operation S225 that another name with a different notation exists, the route generation device 200 may determine whether there is an overlapping area between an origin-destination (OD) minimum bounding rectangle (MBR) and a road MBR (S235). The OD MBR refers to an MBR representing an OD line segment, which is formed by setting an origin and a destination as respective points and connecting the two points with a straight line. The road MBR refers to, when a road or facility (e.g., a bridge) is specified, a rectangle representing an area that includes the entire area of the specified road or facility. Schematic descriptions of the OD MBR and the road MBR will be provided below with reference to FIG. 3.

FIG. 3 is a diagram for describing an overlapping area between an OD MBR and a road MBR in operation S235 of FIG. 2.

Hereinafter, descriptions will be provided with reference to FIG. 2.

In FIG. 3, an OD MBR 310 refers to an MBR that includes an OD line segment formed by setting an origin and a destination as respective points and then connecting the two points with a straight line. In the present disclosure, because the OD MBR 310 is defined as a rectangle including a straight OD line segment, the vertical length of the OD MBR 310 increases as the latitude difference between the origin and the destination increases, and the horizontal length of the OD MBR 310 increases as the longitude difference between the origin and the destination increases.

In FIG. 3, a road MBR 330 refers to, when a road or facility (e.g., a bridge) is specified, a rectangle representing an area that includes the entire area of the specified road or facility. In the present disclosure, because the road MBR 330 is defined as a rectangular area that includes the entire area of a road or facility, the difference in latitude or longitude between the start point and the end point of the road is not necessarily proportional to the horizontal or vertical length of the road MBR 330. For example, when an end point of a certain road is east of its start point, and an intermediate point on the road is even further east than the end point, the horizontal length of the road MBR 330 may be determined as a value proportional to the distance between the start point of the road and the intermediate point on the road.

Subsequently, overlap determination 350 in FIG. 3 is a diagram for describing a determination process performed by the route generation device 200 in operation S235 of FIG. 2. That is, once information about the OD MBR 310 and the road MBR 330 is determined, the route generation device 200 may overlap the two determined pieces of information on a single diagram, and then identify a common (overlapping) area between the two MBRs. The overlapping area between the OD MBR 310 and the road MBR 330 that the route generation device 200 identifies in FIG. 3 may be used to determine a ‘scope of reflection of a road’, which will be described below.

The description of FIG. 2 will be continued.

When it is determined that there is an overlapping area when overlapping the OD MBR and the road MBR, the route generation device 200 may additionally determine whether the road corresponding to the road MBR actually exists within the overlapping area (S240). When it is determined that there is no overlapping area between the OD MBR and the road MBR, or when an overlapping area exists but the road corresponding to the road MBR is not detected as a traversable road within the overlapping area, the route generation device 200 does not provide a route to the user, notifying that the route requested by the user has not been found (S285).

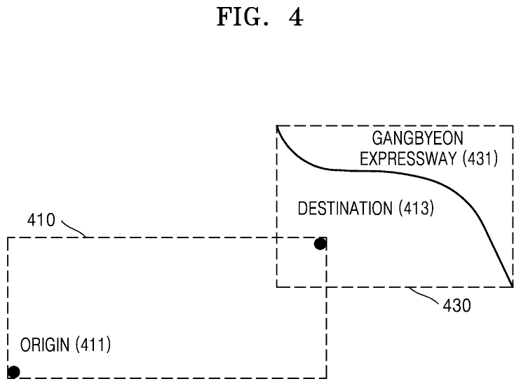

FIG. 4 is a diagram schematically illustrating an example of determining, in operation S240 of FIG. 2, whether a road corresponding to a road MBR actually exists within an overlapping area.

FIG. 4 illustrates an OD MBR 410 that includes a straight line between an origin 411 and a destination 413, and a road MBR 430 that includes Gangbyeon Expressway 431. In FIG. 4, although the route generation device 200 may detect an overlapping area including the Destination 413 when overlapping the OD MBR 410 and the road MBR 430, the route requested by the user is not provided in accordance with operation S285 described above, because the overlapping area does not include Gangbyeon Expressway 431 at all.

As illustrated in FIG. 4, in the present disclosure, the route generation device 200 may efficiently generate a route that reaches a destination via a user-specified road (or facility), by primarily identifying an overlapping area by overlapping an OD MBR and a road MBR, and secondarily determining whether the road corresponding to the road MBR is included in the overlapping area.

The description of FIG. 2 will be continued.

After operations S235 and S240, when the road corresponding to the road MBR is detected in the overlapping area between the OD MBR and the road MBR, the route generation device 200 may additionally determine a grade of the road (S245). For example, when the grade of the road detected in the overlapping area is an ‘urban expressway’, the route generation device 200 may provide a route to the user according to subsequent operations (operations S250 to S280), however, when the grade of the road detected in the overlapping area is a general road, such as a ‘major arterial road, minor arterial road, collector road, or local road’, the route generation device 200 may determine that a route satisfying the conditions has not been found, and thus may not provide a route (S285). In the present disclosure, operation S245 is an optional process, and according to an embodiment, the route generation device 200 may perform operation S240, then omit operation S245 and perform operation S250.

According to settings input by the user when requesting a search for a user-defined route in operation S210, the route generation device 200 may determine whether the road (or facility), which has been determined to exist in operation S240, is a road preferred by the user or a road to be avoided by the user (S250), and based on the determination result, assign a weight to the corresponding road (S255 and S260). When generating a user-defined route, the route generation device 200 may generate a route with the smallest sum of weights of short unit roads included in the user-defined route, and the weights set for the respective roads may be determined by various factors, such as the length of the corresponding road, congestion characteristics of the corresponding road, or the time of day when traveling through the corresponding road. With the weights of the respective roads determined, the route generation device 200 may use a route generation algorithm such as Dijkstra's algorithm or the A* algorithm, and route generation algorithms other than the aforementioned algorithms may also be used.

The route generation device 200 may assign a preference weight when the road determined to exist within the OD MBR in operation S240 is a road preferred by the user, and may newly assign an avoidance weight when the road is a road that the user wants to avoid. A preference weight and an avoidance weight assigned to a certain road may decrease or increase the sum of weights of an entire route that includes the road.

For example, assuming Route 1, which is a user-defined route, has a sum of weights of 100 and includes a road to which a preference weight has been applied, and that Route 2, which is a general route composed only of roads without preference weights, has a sum of weights of 90, the sum of the weights of Route 1 may be lowered from 100 to 80 by the preference weight applied to the Route 1, and accordingly, the route generation device 200 may ultimately generate and output Route 1 whose sum of weights is lower than that of Route 2. As another example, assuming Route 3, which is a user-defined route, has a sum of weights of 100 and includes a road to which an avoidance weight has been applied, due to the avoidance weight, the sum of the weights of Route 3 may increase to 110 or 120, and accordingly, the route generation device 200 may compare Route 3 with other routes to determine that Route 3 is an inefficient route, and thus exclude Route 3.

As described above, after a preference weight or an avoidance weight is assigned to the road determined to exist within the OD MBR in operation S240, the route generation device 200 may search for various routes, including the user-defined route, based on the assigned weight (S265), determine whether the road identified to exist within the OD MBR has been included or avoided in the searched routes due to the preference weight or avoidance weight (S270), and provide a route based on the determination result (S280). Unlike a general route search, the present disclosure aims to find a user-defined route that must pass through or avoid a user-specified road (or facility), and thus, operation S270 described above is included, and according to an embodiment, operation S270 may be included in and performed as part of operation S265.

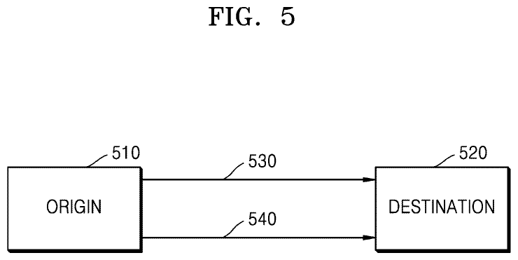

FIG. 5 is a diagram for describing an example of a method according to the present disclosure.

In FIG. 5, an origin 510 and a destination 520 correspond respectively to the origin 411 and the destination 413, which are included in the OD MBR described above with reference to FIG. 4. In FIG. 5, there are a first route 530 and a second route 540 for reaching the destination 520 from the origin 510, and it is assumed that the respective sums of weights of roads that constitute the first route 530 and the second route 540 are 100.

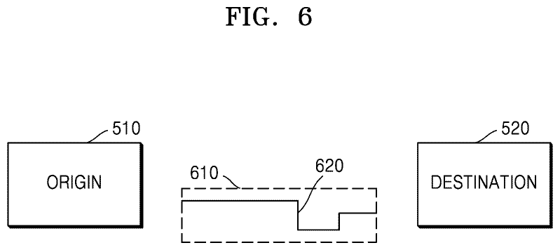

FIG. 6 is a diagram for describing an example of an entire road included in a road MBR.

In FIG. 6, a road MBR 610 includes a user-specified road 620 that is input by a user when requesting a route search from the route generation device 200. Here, the user-specified road 620 is considered to be an entire road that is clearly identified, through the processes of operations S215 to S230 of FIG. 2, as a road that the user intends to include in or exclude from a user-defined route. Referring to FIGS. 5 and 6, it may be seen that the user-specified road 620 is located closer to the second route 540 than to the first route 530, and a part of the user-specified road 620 overlaps the second route 540.

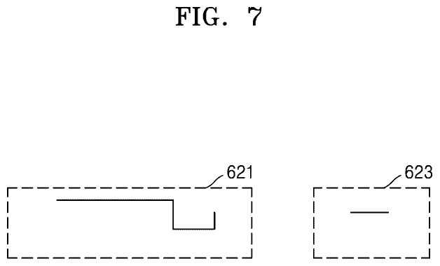

FIG. 7 is a diagram schematically illustrating the user-specified road described above with reference to FIG. 6 divided into two sections.

Hereinafter, descriptions will be provided with reference to FIG. 6.

Referring to FIG. 7, it may be seen that the user-specified road 620 of FIG. 6 is composed of a third route 621 and a fourth route 623 illustrated in FIG. 7. In FIG. 7, the third route 621 is a portion of the user-specified road 620, and refers to a route that does not overlap (is not in common with) the second route 540 of FIG. 5 when overlapping the user-specified road 620 and the second route 540. In FIG. 7, the fourth route 623, similar to the third route 621, is a portion of the user-specified road 620, however, it refers to a route that overlaps the second route 540 of FIG. 5 when overlapping the user-specified road 620 and the second route 540.

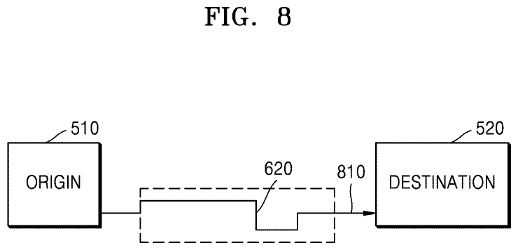

FIG. 8 is a diagram schematically illustrating an example in which a user-specified road is fully reflected in a user-defined route by a method according to the present disclosure.

Referring to FIG. 8, it may be seen that a fifth route 810 in which the user-specified road 620 is fully reflected is generated between the origin 510 and the destination 520. The fifth route 810 refers to a route generated by the route generation device 200 overlapping the second route 540 described above with reference to FIG. 5 and the user-specified road 620 described above with reference to FIG. 6, and increasing the priority of the user-specified road 620 to maximize the scope of reflection of the user-specified road 620. The fifth route 810 is identical to the first route 530 and the second route 540 in that it is a route from the origin 510 to the destination 520, however, it differs from the first route 530 and the second route 540 in that it is for traveling from the origin 510 to the destination 520 via all sections of the user-specified road 620.

According to the embodiment described above with reference to FIG. 8, the fifth route 810 may be generated as a user-defined route that best meets the user's requirements, in that it reflects the highest proportion of the road that the user prefers to pass through (i.e., the user-specified road).

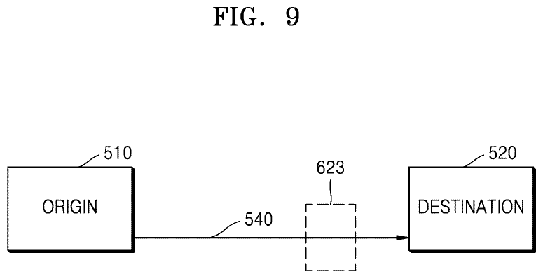

FIG. 9 is a diagram schematically illustrating an example in which a user-specified road is partially reflected in a user-defined route by a method according to the present disclosure.

Referring to FIG. 9, it may be seen that the second route 540 in which the user-specified road 620 is partially reflected is generated between the origin 510 and the destination 520. The second route 540 refers to a route generated by the route generation device 200 overlapping the second route 540 described above with reference to FIG. 5 and the user-specified road 620 described above with reference to FIG. 6, and minimizing the priority of the user-specified road 620 to minimize the scope of reflection of the user-specified road 620. When overlapping the second route 540 of FIG. 5 and the user-specified road 620 of FIG. 6, the fourth route 623, which is a part of the user-specified road 620, forms an overlapping area with the second route 540. In conditions such as those of FIG. 9, because the user-defined route between the origin 510 and the destination 520 only needs to pass through a part of the user-specified road 620, the route generation device 200 generates, as the user-defined route, the second route 540, which corresponds to the shortest route between the origin 510 and the destination 520, and the third route 621 is not reflected in the user-defined route (i.e., the second route 540 in FIG. 9) and is discarded.

Ultimately, referring to FIGS. 8 and 9, it may be seen that, when a preference weight is applied to the user-specified road, an appropriate value is applied as the preference weight such that the sum of weights of a route including the user-specified road is necessarily less than the sums of weights of other routes that do not include the user-specified road.

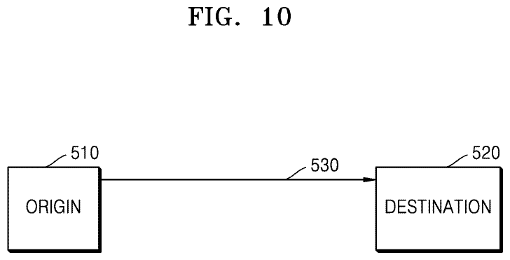

FIG. 10 is a diagram schematically illustrating another example in which a user-specified road is partially reflected in a user-defined route by a method according to the present disclosure.

FIGS. 8 and 9 are diagrams for describing a case in which a preference weight is applied to a user-specified road, whereas FIG. 10 illustrates a case in which an avoidance weight is applied to a user-specified road. In the present disclosure, an avoidance weight serves to increase the sum of weights of an entire route that includes a user-specified road, and thus, a route including a user-specified road to which an avoidance weight has been applied is not provided to the user by the route generation device 200 as a route for traveling from the origin 510 to the destination 520.

FIG. 10 illustrates a case in which an avoidance weight is assigned to the user-specified road 620, and when comparing FIG. 5 with 10, the route generation device 200 may generate, as a user-defined route for traveling from the origin 510 to the destination 520, the first route 530, which does not overlap the user-specified road 620 at all, rather than the second route 540, which includes the fourth route 623 that is a part of the user-specified road 620, and then output the first route 530 as a result value.

FIG. 11 is a flowchart illustrating an example of a method according to the present disclosure.

The method of FIG. 11 may be implemented by the route generation device 200 described above with reference to FIG. 1 or FIG. 2, and thus, the descriptions provided above with reference to FIGS. 2 to 10 will be omitted.

The route generation device 200 may determine whether a received route generation input includes an input about a road (S1110). In operation S1110, the route generation input refers to a user's input provided to the route generation device 200 to generate a user-defined route, and the ‘input about a road’ refers to an input, which is made via typing, voice, or the like, of a name of a road or facility that the user prefers to pass through or to avoid. That is, the input about a road may be considered as an input about a name of a user-specified road.

In operation S1110, the route generation input may further include information about a destination of the route. For example, the user may make a voice input of “Take me to Galleria Department Store via Gangbyeon Expressway” to the route generation device 200, and the route generation device 200 may then generate a user-defined route from the user's current location to the destination, i.e., Galleria Department Store, via Gangbyeon Expressway.

When the received route generation input includes an input about a road, the route generation device 200 may determine the validity of the input and, based on the validity determination result, optionally correct the input about the road (S1130).

Determining the validity of an ‘input about a road’ in operation S1130 is a process corresponding to operations S210 and S215 of FIG. 2, and refers to determining whether the route search request in operation S205 includes, in addition to the destination, an ‘input about a road’, which is considered as a name of a road that the user wishes to pass through or necessarily avoid, and when the route search request includes the ‘input about a road’, determining whether the ‘input about a road’ is a name of a road or a name of a facility such as a bridge. In operation S1130, when the route generation input includes an ‘input about a road’, and a search for that input finds a road name or a facility name, the route generation device 200 may determine that the input is valid, and as a next process, optionally correct the ‘input about a road’.

That the ‘input about a road’ is optionally corrected in operation S1130 means that, according to an embodiment, there may be cases in which the correction is not performed. For example, when the user inputs, to the route generation device 200, a request to search for a route including ‘Naebu Expressway’, because ‘Naebu Expressway’ is an actually existing road name, the route generation device 200 may proceed directly to the next process to generate a user-defined route, without needing to additionally search for another name for ‘Naebu Expressway’ in operation S225 of FIG. 2 or correct a misspelling in operation S230 of FIG. 2.

As an embodiment, in operation S1130, the route generation device 200 may determine the validity of the ‘input about a road’ based on whether the input matches any one of road names, tunnel names, bridge names, and facility names stored in a database. The present embodiment corresponds to operation S220 of FIG. 2, and the route generation device 200 may ascertain whether the name of the road or facility that the user wishes to pass through or avoid is an actually existing name, and when the name actually exists, determine that the input is valid, and when the name does not actually exist, determine that the input is invalid.

As another embodiment, in operation S1130, the route generation device 200 may correct the ‘input about a road’ based on another name, a nickname, or an old name for the ‘input about a road’. In the present embodiment, another name refers to a homonym. For example, the road named ‘Jayu-ro’ primarily refers to a national highway included in National Route 77 located in the Republic of Korea, but roads with the same name also exist in Gunsan-si, Jeollabuk-do, and Mokpo-si, Jeollanam-do, and thus, the route generation device 200 may correct the road referred to by ‘Jayu-ro’ to another name based on the user's location, and then perform a search.

In addition, the road name ‘Guma Expressway’ is the old name for the ‘Jungbu Naeryuk Expressway Branch’, and thus, when ‘Guma Expressway’ is provided as an input about a road, the route generation device 200 may search for ‘Jungbu Naeryuk Expressway Branch’ in a database to generate a user-defined route. In this process, the route generation device 200 may use an algorithm capable of paraphrasing an ‘input about a road’.

As yet another embodiment, in operation S1130, the route generation device 200 may correct a misspelling in the ‘input about a road’. The present embodiment has been described above with reference to operation S230 of FIG. 2.

Subsequently, the route generation device 200 may compare a first area based on the route generation input, with a second area based on the ‘input about a road’, to determine a scope of reflection of the road or facility included in the ‘input about a road’ (S1150). In operation S1150, the route generation device 200 may define the first area as a rectangular range generated based on the origin and the destination included in the route generation input, and the second area as a rectangular range generated based on the ‘input about a road’, and determine the scope of reflection of the road or facility included in the ‘input about a road’, based on an overlap between the first area and the second area.

In operation S1150, the first area may be the OD MBR of FIG. 3. Furthermore, in operation S1150, the second area may be the road MBR of FIG. 3. In operation S1150, the process in which the route generation device 200 determines the scope of reflection of the road or facility by comparing the first area with the second area refers to identifying an overlapping area by overlapping the OD MBR and the road MBR of FIG. 3, and determining the area of the road or facility within the overlapping area as a pass-through area.

In operation S1150, the route generation device 200 may determine the scope of reflection of the road based on a road that is common to both the first area and the second area. In detail, the route generation device 200 may determine the scope of reflection based on an overlap between the line defined by the origin and the destination in the first area, and the road (user-specified road) included in the second area, and this has been described above with reference to FIG. 4.

The route generation device 200 may generate a user-defined route that reflects the scope of reflection determined in operation S1150 (S1170). In operation S1170, the user-defined route refers to an optimal route to a user-specified destination, which necessarily include at least a part of a road the user wishes to pass through, or that necessarily avoid a road that the user wishes to avoid. The method of generating a route in operation S1170 may use, but is not limited to, known algorithms such as Dijkstra's algorithm or the A* algorithm.

In operation S1170, the route generation device 200 may determine whether a preferred point to which a first weight is assigned exists in the first area, and generate a user-defined route to include the preferred point based on the first weight. The present embodiment has been described above with reference to FIGS. 5 to 9, and the first weight may be referred to as a preference weight.

Furthermore, in operation S1170, the route generation device 200 may determine whether an avoidance point to which a second weight is assigned exists in the first area, and generate a user-defined route to necessarily exclude the avoidance point based on the second weight. The present embodiment has been described above with reference to FIGS. 5 to 10, and the second weight may be referred to as an avoidance weight.

FIG. 12 is a block diagram illustrating an example of a route generation device.

Referring to FIG. 12, a route generation device 1200 may include a communication unit 1210, a processor 1220, and a database (DB) 1230. FIG. 12 illustrates the route generation device 1200 including only components associated with an embodiment. Therefore, it would be understood by those of skill in the art that other general-purpose components may be further included in addition to those illustrated in FIG. 12.

The communication unit 1210 may include one or more components for performing wired/wireless communication with an external server or an external device. For example, the communication unit 1210 may include at least one of a short-range communication unit (not shown), a mobile communication unit (not shown), and a broadcast receiver (not shown).

The DB 1230 is hardware for storing various pieces of data processed by the route generation device 1200, and may store a program for the processor 1220 to perform processing and control.

The DB 1230 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1220 controls the overall operation of the route generation device 1200. For example, the processor 1220 may execute programs stored in the DB 1230 to control the overall operation of an input unit (not shown), a display (not shown), the communication unit 1210, the DB 1230, and the like. The processor 1220 may execute programs stored in the DB 1230 to control the operation of the route generation device 1200.

The processor 1220 may control at least some of the operations of the route generation device 200 described above with reference to FIGS. 1 to 11.

For example, the processor 1220 may determine whether a received route generation input includes an input about a road, determine, based on the route generation input including the input about the road, the validity of the input, optionally correct the input about the road based on the determination result, determine a scope of reflection of the road by comparing a first area based on the route generation input with a second area based on the input about the road, and generate a user-defined route that reflects the determined scope of reflection.

The processor 1220 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

The embodiments of the present disclosure described above may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

Particular executions described herein are merely examples and do not limit the scope of the present disclosure in any way. For the sake of brevity, related-art electronics, control systems, software and other functional aspects of the systems may not be described in detail. Furthermore, line connections or connection members between elements depicted in the drawings represent functional connections and/or physical or circuit connections by way of example, and in actual applications, they may be replaced or embodied with various suitable additional functional connections, physical connections, or circuit connections. In addition, no item or component is essential to the practice of the present disclosure unless the item or component is specifically described as being “essential” or “critical”.

The term ‘the’ and other demonstratives similar thereto in the specification of the present disclosure (especially in the following claims) should be understood to include a singular form and plural forms. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to those skilled in the art without departing from the spirit and scope of the present disclosure.

According to the present disclosure, a route that meets a user's needs may be generated.

Furthermore, according to the present disclosure, a methodology may be provided for accurately generating a route that includes a point that a user wishes to pass through, or does not include a point that the user wishes to avoid, and displaying the generated route on a navigation system.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of generating a road-based, user-defined route, the method comprising:
determining whether a received route generation input comprises an input about a road;
determining, based on the route generation input comprising the input about the road, a validity of the input and optionally correcting the input based on a result of the determining of the validity;
determining a scope of reflection of the road by comparing a first area based on the route generation input with a second area based on the input; and
generating a user-defined route that reflects the determined scope of reflection.

2. The method of claim 1, wherein the route generation input further comprises information about a destination of the route.

3. The method of claim 1, wherein the input about the road is an input via a voice of a user.

4. The method of claim 1, wherein the correcting of the input comprises determining the validity of the input based on whether the input matches any one of road names, tunnel names, bridge names, and facility names that are stored in a database.

5. The method of claim 1, wherein the correcting of the input comprises correcting a misspelling in the input about the road.

6. The method of claim 1, wherein the correcting of the input comprises correcting the input about the road based on another name, a nickname, or an old name for the input about the road.

7. The method of claim 1, wherein the determining of whether the received route generation input comprises the input about the road comprises paraphrasing the input about the road and then determining whether the received route generation input comprises the input about the road.

8. The method of claim 1, wherein the determining of the scope of reflection of the road comprises defining a first area as a rectangular range generated based on an origin and a destination included in the route generation input, defining a second area as a rectangular range generated based on the input, and determining the scope of reflection based on an overlap between the first area and the second area.

9. The method of claim 8, wherein the determining of the scope of reflection of the road further comprises determining the scope of reflection based on a road that is common to both the first area and the second area.

10. The method of claim 1, wherein the determining of the scope of reflection of the road comprises determining the scope of reflection based on an overlap between a line defined by an origin and a destination in the first area, and a road in the second area.

11. The method of claim 1, wherein the generating of the user-defined route comprises:
determining whether a preferred point to which a first weight is assigned exists in the first area; and
generating the user-defined route such that the preferred point is included in the user-defined route based on the first weight.

12. The method of claim 1, wherein the generating of the user-defined route comprises:
determining whether an avoidance point to which a second weight is assigned exists in the first area; and
generating the user-defined route such that the avoidance point is excluded from the user-defined route based on the second weight.

13. A computer-readable recording medium having stored therein a program for executing the method of claim 1.

14. A device for generating a road-based, user-defined route, the device comprising:
a memory storing at least one program; and
a processor configured to execute the at least one program to perform an operation,
wherein the processor is further configured to determine whether a received route generation input comprises an input about a road, determine, based on the route generation input comprising the input about the road, a validity of the input and optionally correct the input based on a result of the determining of the validity, determine a scope of reflection of the road by comparing a first area based on the route generation input with a second area based on the input, and generate a user-defined route that reflects the determined scope of reflection.
